(19) United States
(12) Patent Application Publication
(10) Pub. No.: US 2004/0065850 A1
(43) Pub. Date: Apr. 8, 2004

(54) Thermal imaging identification signage

(76) Inventor: Todd A. Kane, Peoria, AZ (US)

Correspondence Address: STURM & FIX LLP, 206 SIXTH AVENUE, SUITE 1213, DES MOINES, IA, 50309-4076, US

(21) Appl. No.: 10/262,823

(22) Filed: Oct. 2, 2002

(51) Int. Cl. G08B 5/00

(52) U.S. Cl. 250/495.1

(57) ABSTRACT

Rapid, positive identification in a wide variety of lighting and visibility conditions is a must in combat and rescue operations. With modern imaging technology, both thermal and infrared radiation can be made visible to the human eye. By combining shape, color, heat, and infrared reflectivity, easily identifiable symbols can be made to be placed on vehicles, buildings, runways, landing pads, and personnel and can be made to be visible in all kinds of lighting. To be visible using thermal imaging technology, such symbols must have a temperature that is different from their surroundings—either colder or hotter. Symbols can be heated using resistance heat, by passing a hot fluid through a panel that makes up the symbol, or from an exothermic chemical reaction. Symbols can be cooled using a cold fluid passing through a panel, or an endothermic chemical reaction. A thermal radiation reflecting sleeve or envelope can be fitted over the heated panel. The sleeve has a hole or holes cut into it in certain shapes such that the panel can be seen through it. A significant temperature difference is only detected at the hole or holes cut into the sleeve. The sign is, then, easily identifiable using thermal imaging technology.

### BACKGROUND OF THE INVENTION

1. Field of the Invention

The present invention relates generally to a method and apparatus for providing identification for objects and persons in situations such as combat and rescue operations. More particularly the present invention incorporates color, heat, shape, infrared reflection, and digital technologies to provide rapid, positive identification to landing pads or strips, buildings, vehicles and personnel involved in rescue operations and combat. Color can be identified during daylight hours. Heat can be detected at any time of the day using heat-sensing technology, infrared light and digital signals can be picked up regardless of other lighting. Shape (including orientation) can be used to differentiate companies, landing strips, secured buildings, etc.

2. Background Art

Present day technologies for locating sources of heat, or detecting objects in low lighting situations is very advanced. However, technologies for determining quickly and accurately whether a sighted object is that being sought, or whether it is friend or foe have not kept up with the aforementioned technologies.

Generally, when an object is detected, whether the image is produced by a device for detecting objects in low lighting conditions or by the unaided eye, the identification of that object remains a judgment call by the one sighting the object. The shape of the overall object (and the orientation of that shape), location of hot or cold areas, and other identifying features are used to make that judgment. Often, the identification must be made in a very brief time, to avoid being fired upon by friendly forces, or to touch down an aircraft in adverse conditions, or to make a rescue and transfer those rescued to medical help as needed. In the case of personnel, there is often little to distinguish between soldiers of one side from those of another side, and this is aggravated by low visibility conditions or when only a small portion of a person is visible due to obstructions.

There is, therefore, a need for ways to accurately, quickly and positively identify various objects in combat, rescue, and aircraft landing situations.

### SUMMARY OF THE INVENTION

A purpose of this invention is to provide a method and apparatus for providing quick, accurate identification for weapons, aircraft, vehicles, buildings, landing strips, landing pads, and personnel involved in activities such as combat or rescue operations.

Color can provide can provide quick, easily recognized, and positive identification of objects that are potential targets, landing strips or other objectives of a mission. However, colors are only visible in conditions of significant lighting. Simple shapes, such as circles, squares, rectangles, and triangles (oriented in predetermined directions) provide positive identification for the same objects. Shapes can be formed by the aforementioned color, or using infrared reflective materials, and even heat. These shapes can be detected visually, with technology to make them visible to the human eye, even in conditions of limited lighting. Such technology includes Forward Looking Infrared (FLIR) and Thermal Imaging Systems (TIS). Then, the same device can be embedded with an electronic chip to transmit a digital response to a remote inquiry, providing still another source of identification of the object on which the device is mounted or placed.

Thermal imaging technology actually detects differences in temperature. According to the Stefan-Boltzman law, heat is emitted from a body at a rate proportional to the fourth power of the temperature:

\dot{Q}∝T⁴

where \dot{Q} is the rate of heat transfer and T is the absolute temperature. Therefore, the emission of heat by radiation is a strong function of the body's temperature.

Any device to provide a temperature signature, detectable with heat detection instruments, must produce a difference in temperature compared to its surroundings. Thus, an identification device might be colder or hotter than its surroundings. A higher temperature can be made by electrical resistance heat using a building's utility lines, a vehicle's electrical system, or battery power to provide the energy needed. Other ways of producing the temperature difference are chemical reactions (either endothermic or exothermic), hot water, and refrigeration.

Using any source of temperature difference, a flat, rectangular “thermal” panel can be constructed having this temperature difference significantly over all its surface. A sleeve that fits over the panel can be constructed. By cutting a hole into the sleeve and providing it with appropriate thermal radiation barriers such as a reflective liner and/or an air space, significant temperature difference will only be detectable within the hole. The shape of the hole and its orientation provide the positive identification. The same thermal panel can be used with a variety of sleeves for any application within the scope of any mission.

The same panel can be impregnated with an infrared reflective material. The sleeve also covers up a portion of this reflective surface, leaving only the same shape that will reflect infrared light.

The same panel and sleeve can have contrasting and meaningful colors that are visible any time the lighting and distance conditions permit identification with the naked eye or with simple aids such as binoculars or a scope.

Finally, the same sleeve can have an electronic chip mounted on or in it to provide a transmitted response to an electronic inquiry from a remote device. The digital signature returned by the chip will provide another source of positive identification regardless of lighting conditions or even objects blocking the panel/sleeve from direct sight.

An alternative to the panel/sleeve approach is to have the region of temperature difference be formed in a particular shape. This can be accomplished by placing electric resistance elements in a particular shape, containing a chemical reaction to a particular shape, or shaping a water jacket in a particular shape. Color and infrared reflecting coatings can also take on that same shape.

The thermal panel and sleeve can be made of a variety of materials, and this invention is not limited to a particular material. There will be applications in which it will be most suitable for the panel/sleeve to be rigid, while other applications will call for a flexible sleeve that can be folded, rolled, or even wadded up to take less space when not in use.

### BRIEF DESCRIPTION OF THE DRAWINGS

FIG. 1 shows a schematic of a thermal panel.

FIG. 2 shows a schematic of a sleeve with a shape cut into it.

FIG. 3 shows a schematic of a thermal pad with a shaped thermal element.

FIG. 4 shows an identification sign mounted on a military tank.

FIG. 5 shows a thermal panel rolled up.

FIG. 6 shows a thermal panel folded up.

FIG. 7 is a view like FIG. 4, but showing the thermal panel rotated 180 degrees from the FIG. 4 position.

FIG. 8 is a view like FIG. 4, but showing the thermal panel rotated 90 degrees from the FIG. 4 position.

### BEST MODE FOR CARRYING OUT THE INVENTION

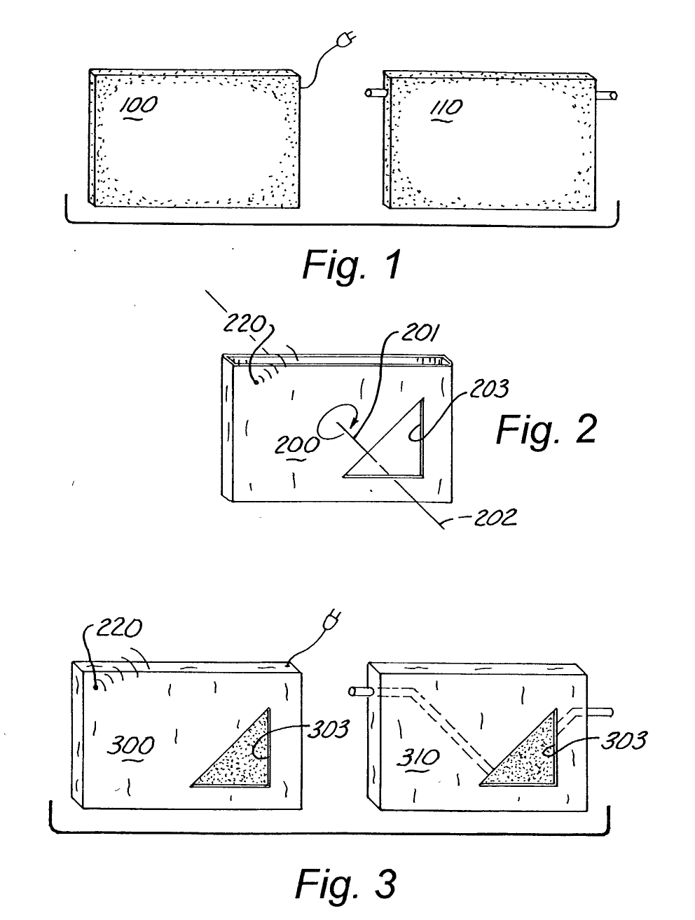

A schematic depiction of two thermal panels 100 and 110 are shown in FIG. 1. The required source of temperature difference (from the surroundings) is produced in panel 100 by resistance heat. In panel 110, a hot fluid such as heated water or exhaust gases; a cold fluid such as a refrigerant from a refrigeration system or cold water; or a chemical reaction (either endothermic or exothermic) provide the required temperature difference. In the case of FIG. 1, the temperature difference appears throughout the surface of panels 100 and 110.

The same panels 100 and 110 can be coated or impregnated with an infrared (IR) reflective material to be visible by Forward Looking Infrared (FLIR) systems. The color of panels 100 and 110 shall also be chosen to be visible to the naked (or simply aided, e.g. with binoculars or scope) eye in appropriate lighting.

FIG. 2 shows a sleeve 200 into which thermal panel 100 fits. Sleeve 200 is lined with a thermal radiation barrier such as a shiny metallic coating. Sleeve 200 fits such that a gap exists between panel 100 and sleeve 200 to provide an additional thermal barrier to assure that the temperature difference detected is isolated to a given shape which is cut into (through one or more surfaces) sleeve 200. The shape 203 shown in sleeve 200 is a triangle, but this invention requires that many shapes be possible.

Mounted on or in sleeve 200 is an electronic chip 220 for transmitting a response to a remote inquiry. Chip 220 replies to appropriate inquiry with an identification code to provide still another form of positive identification. Such a chip 220 is best mounted on or in sleeve 200 because sleeve 200 is the unique identification feature of this configuration.

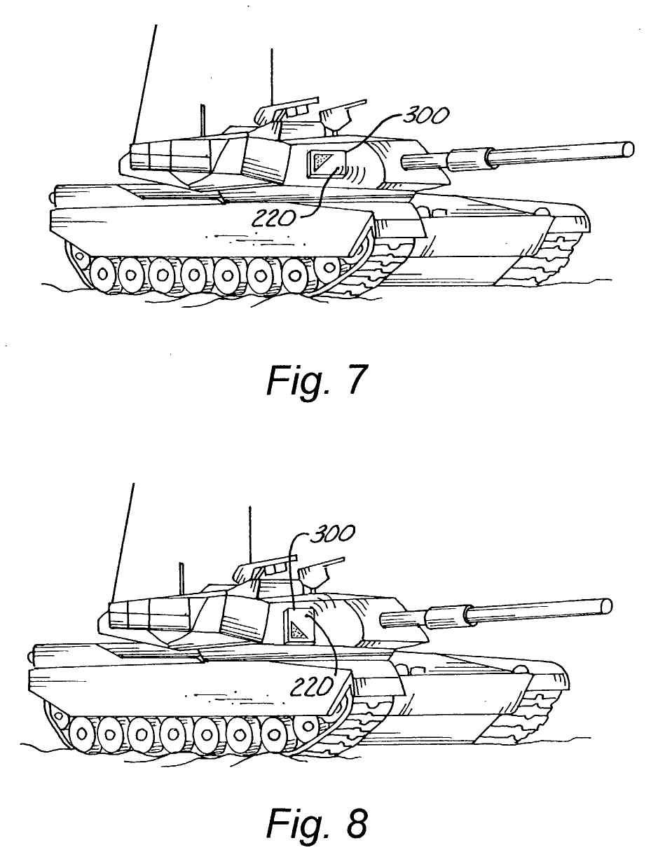

The orientation of the triangular opening 203 in sleeve 200 can be changed by merely rotating sleeve 200 and panel 100 about axis 202, which passes through point 201. For example, the orientation of FIG. 2 might be used on day one, a position corresponding to 180° orientation from FIG. 2 on day two (see FIG. 7) and an orientation of 90° from that of FIG. 2 on day three as shown in FIG. 8. This changing of the orientation from day to day deters enemy forces from imitating the signage.

Another use of changing orientation is that of identifying different companies. Thus, Company A might orient their signage as shown in FIG. 2, Company B might, instead use the orientation shown in FIG. 7, while Company C might be identified by the orientation shown in FIG. 8.

Still another use of orientation can be for indicating direction. Thus, a triangle pointing upward might indicate a building is secured from the location of the signage upward. A landing strip might be indicated by a set of signages, all with triangle pointing inward toward the landing strip.

An additional embodiment is shown in FIG. 3. Here, thermal panels 300 and 310 are shown in which the required thermal difference only occurs in a particular shape 303. This is accomplished in panel 300 by confining the electrical resistance element(s) to the required shape 303 (shown, again, as a triangle, but this invention is not limited to a triangle). In panel 310, fluid, or a chemical reaction is restricted to the shape 303 required. The color and infrared reflecting material are also confined to the same shape 303. Electronic chip 220 is also shown in FIG. 3.

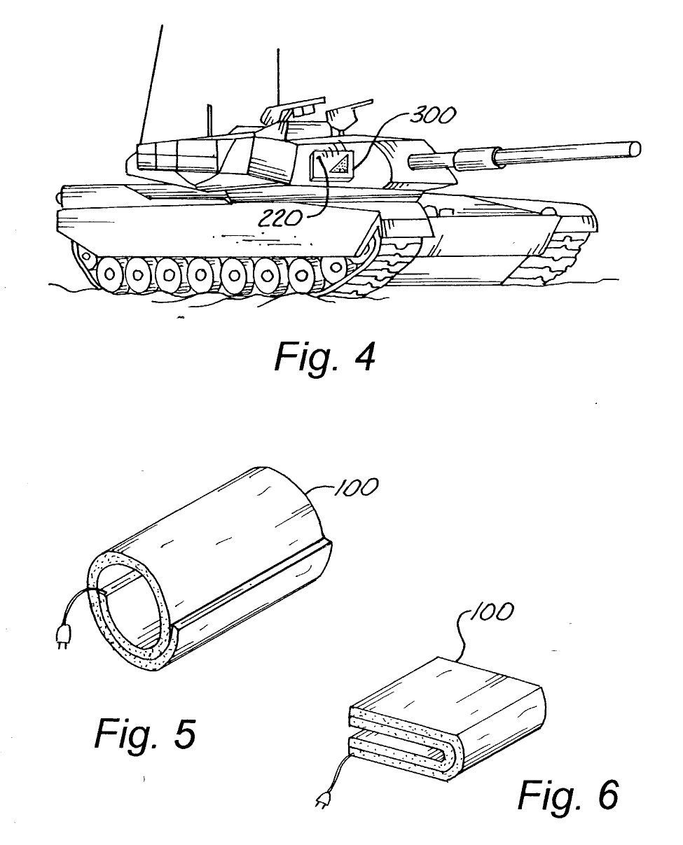

An identification sign (100 with sleeve 200, or standalone panel 300) is shown in FIG. 4, mounted on a military tank. This is only one of many examples, as already disclosed. Other applications include buildings, runways, landing pads, personnel, aircraft, and motor vehicles.

In many applications, it is desirable that a thermal panel and sleeve be rolled up, folded up, or even wadded up to reduce its size for ease of transport. FIG. 5 shows a depiction of a thermal panel 100 having been rolled up. The sleeve 200 may or may not be rolled up with the thermal panel. In FIG. 6 the thermal panel 100 has been folded up. Again, the sleeve 200 may or may not be folded up with the panel.

Obviously many modifications and variations of the present invention are possible in light of the above teachings. It is, therefore, to be understood that within the scope of the appended claims, the invention may be practiced otherwise than as specifically described.

I claim:

1. A method for providing positive identification when using thermal imaging technology, the method comprising
(a) a panel;
(b) said panel having a temperature difference compared with its surroundings; and
(c) said temperature difference appearing on the panel in a predetermined shape.

2. The method of claim 1 wherein the temperature difference on the panel is produced by resistance heat.

3. The method of claim 1 wherein the temperature difference on the panel is produced by passing a fluid having a temperature different from the surroundings through the panel.

4. The method of claim 1 wherein the temperature difference on the panel is produced by a chemical reaction.

5. The method of claim 1 wherein the panel's temperature is lower than the surroundings.

6. The method of claim 1 wherein the panel's temperature is higher than the surroundings.

7. The method of claim 1 including a sleeve fitting over the panel, said sleeve comprising
(a) a radiant barrier to effectively block thermal radiation from crossing the radiant barrier; and
(b) a predetermined shape cut into said sleeve through which thermal radiation can be emitted.

8. The method of claim 7 including an air gap between the panel and the sleeve.

9. The method of claim 1 including a sleeve fitting over the panel, said sleeve comprising
(a) a radiant barrier, formed into predetermined shape, to effectively block thermal radiation from crossing the radiant barrier; and
(b) a remainder of the sleeve made to permit emission of thermal radiation outside the predetermined shape.

10. The method of claim 9 including an air gap between the panel and the sleeve in a region of the radiant barrier in the predetermined shape.

11. The method of claim 1 wherein the panel is flexible.

12. The method of claim 11 wherein the panel can be rolled up.

13. The method of claim 11 wherein the panel can be folded up.

14. The method of claim 1 wherein the panel is colored to be visible against its surroundings.

15. The method of claim 1 wherein the panel reflects infrared radiation such that it can be seen using forward looking infrared technology.

16. The method of claim 1 wherein an electronic chip is mounted on the panel, said electronic chip transmits an identification response to a remote inquiry.

17. The method of claim 7 wherein an electronic chip is mounted on the sleeve, said electronic chip transmits an identification response to a remote inquiry.

18. An apparatus for providing positive identification when using thermal imaging technology, the apparatus comprising
(a) a panel;
(b) a means to cause said panel to have a temperature difference compared with its surroundings; and
(c) means to contain said temperature difference on the panel to a predetermined shape.

19. The apparatus of claim 18 wherein the means to cause the temperature difference on the panel is resistance heat.

20. The apparatus of claim 18 wherein the means to cause the temperature difference on the panel is by passing a fluid having a temperature different from the surroundings through the panel.

21. The apparatus of claim 18 wherein the means to cause the temperature difference on the panel is a chemical reaction.

22. The apparatus of claim 18 including means to make the panel's temperature lower than the surroundings.

23. The apparatus of claim 18 including means to make the panel's temperature higher than the surroundings.

24. The apparatus of claim 18 including a sleeve that fits over the panel, said sleeve comprising
(a) a radiant barrier to block thermal radiation from crossing the sleeve; and
(b) a predetermined shape cut into said sleeve through which thermal radiation can be emitted.

25. The apparatus of claim 24 including an air gap between the panel and the sleeve.

26. The apparatus of claim 18 including a sleeve fitting over the panel, said sleeve comprising
(a) a radiant barrier, formed into predetermined shape, to effectively block thermal radiation from crossing the radiant barrier means; and
(b) means to permit emission of thermal radiation outside the predetermined shape on a remainder of the sleeve made to permit.

27. The apparatus of claim 26 including an air gap between the panel and the sleeve in a region of the radiant barrier in the predetermined shape.

28. The apparatus of claim 18 wherein the panel is flexible.

29. The apparatus of claim 28 wherein the panel can be rolled up.

30. The apparatus of claim 28 wherein the panel can be folded up.

31. The apparatus of claim 18 wherein the panel is made of a predetermined color to be visible against its surroundings.

32. The apparatus of claim 18 wherein the panel is constructed of a material which reflects infrared radiation such that it can be seen using forward looking infrared technology.

33. The apparatus of claim 18 including an electronic chip transmitter is mounted on the panel, said electronic chip transmitter transmits an identification response to a remote inquiry.

34. The apparatus of claim 24 wherein an electronic chip transmitter is mounted on the sleeve, said electronic chip transmitter transmits an identification response to a remote inquiry.
